(19) United States
(12) Patent Application Publication
(10) Pub. No.: US 2013/0346558 A1
(43) Pub. Date: Dec. 26, 2013

(54) DELIVERY CONTROLLER BETWEEN CLOUD AND ENTERPRISE

(71) Applicants: Yousef A. Khalidi, Bellevue, WA (US); Deepak Bansal, Redmond, WA (US); Changhoon Kim, Bellevue, WA (US); Srikanth Kandula, Redmond, WA (US); David A. Maltz, Bellevue, WA (US); Parveen Patel, Redmond, WA (US)

(72) Inventors: Yousef A. Khalidi, Bellevue, WA (US); Deepak Bansal, Redmond, WA (US); Changhoon Kim, Bellevue, WA (US); Srikanth Kandula, Redmond, WA (US); David A. Maltz, Bellevue, WA (US); Parveen Patel, Redmond, WA (US)

(73) Assignee: MICROSOFT CORPORATION, Redmond, WA (US)

(21) Appl. No.: 13/530,054

(22) Filed: Jun. 21, 2012

(51) Int. Cl. G06F 15/16

(52) U.S. Cl. 709/218; 709/217

(57) ABSTRACT

A delivery controller for use in an enterprise environment that communicates with a cloud computing environment that is providing a service for the enterprise. As the cloud service processing progresses, some cloud service data is transferred from the cloud computing environment to the enterprise environment, and vice versa. The cloud service data may be exchanged over any one of a number of different types of communication channels. The delivery controller selects which communication channel to use to transfer specific data, depending on enterprise policy. Such policy might consider any business goals of the enterprise, and may be applied at the application level.

### BACKGROUND

“Cloud computing” is a model for enabling ubiquitous, convenient, on-demand network access to a shared pool of configurable computing resources (e.g., networks, servers, storage, applications, and services). The shared pool of configurable computing resources can be rapidly provisioned via virtualization and released with low management effort or service provider interaction, and then scaled accordingly. A cloud computing model can be composed of various characteristics (e.g., on-demand self-service, broad network access, resource pooling, rapid elasticity, measured service, etc), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). An environment that implements the cloud computing model is often referred to as a cloud computing environment.

In a typical enterprise environment, some of the data associated with a cloud service performed for the enterprise is kept in the cloud, and other data is kept within the enterprise. As the cloud service progresses, data is thus exchanged between the cloud and the enterprise in order to support the service processing. Such data can be exchanged over a network such as the Internet. Alternatively, a dedicated end-to-end channel may be used that is dedicated for communications between the enterprise and the cloud service.

### BRIEF SUMMARY

At least one embodiment described herein relates to a system in which an enterprise environment communicates with a cloud computing environment so that the cloud computing environment can provide a cloud service to the enterprise. Some of the cloud service data is present on the cloud computing environment, but some of the cloud service data is kept in the enterprise environment. As the cloud service processing progresses, some cloud service data is transferred from the cloud computing environment to the enterprise environment, and vice versa.

In accordance with at least one embodiment described herein, the cloud service data may be exchanged over any one of a number of different types of communication channels. As an example, the data may be transferred over a dedicated communication channel dedicated between the cloud computing environment and the enterprise environment, and some of the data may be transferred over a non-dedicated communication channel, such as the Internet.

The enterprise environment includes a delivery controller that is configured to select which communication channel to use to transfer specific data, depending on enterprise policy. Such policy might consider any business goals of the enterprise, and may be applied at the application level. Thus, even cloud service data having to do with the same cloud service might be transferred over different channels to advance the business goals of the enterprise.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates a computing system in which some embodiments described herein may be employed;

FIG. 2 illustrates a distributed system that includes an enterprise environment and a cloud computing environment in which a cloud service is performed on behalf of the enterprise environment, and in which a delivery controller manages which channel cloud data is communicated over in accordance with the principles described herein;

FIG. 3 illustrates a conceptual abstract diagram showing examples of application-level policy;

FIG. 4 illustrates a flowchart of a method for communicating cloud service data from an enterprise environment to a cloud service in a cloud computing environment using a delivery controller to select which communication channel to use in exchanging cloud data in accordance with the principles described herein;

FIG. 5 illustrates a system that is similar to the system of FIG. 2 except that there are multiple cloud computing environments;

FIG. 6 illustrates a system that is similar to the system of FIG. 2 except that a single cloud computing environment services multiple enterprise environments;

FIG. 7 abstractly illustrates a cloud computing environment in which the principles described herein may be employed; and

FIG. 8 abstractly illustrates a host computing system as including virtual machines, a hypervisor, physical resources and a host agent.

### DETAILED DESCRIPTION

In accordance with embodiments described herein, a system in which an enterprise environment communicates with a cloud computing environment is described. The cloud computing environment can provide a cloud service to the enterprise. Some of the cloud service data is present on the cloud computing environment, but some of the cloud service data is kept in the enterprise environment. As the cloud service processing progresses, some cloud service data is transferred from the cloud computing environment to the enterprise environment, and vice versa.

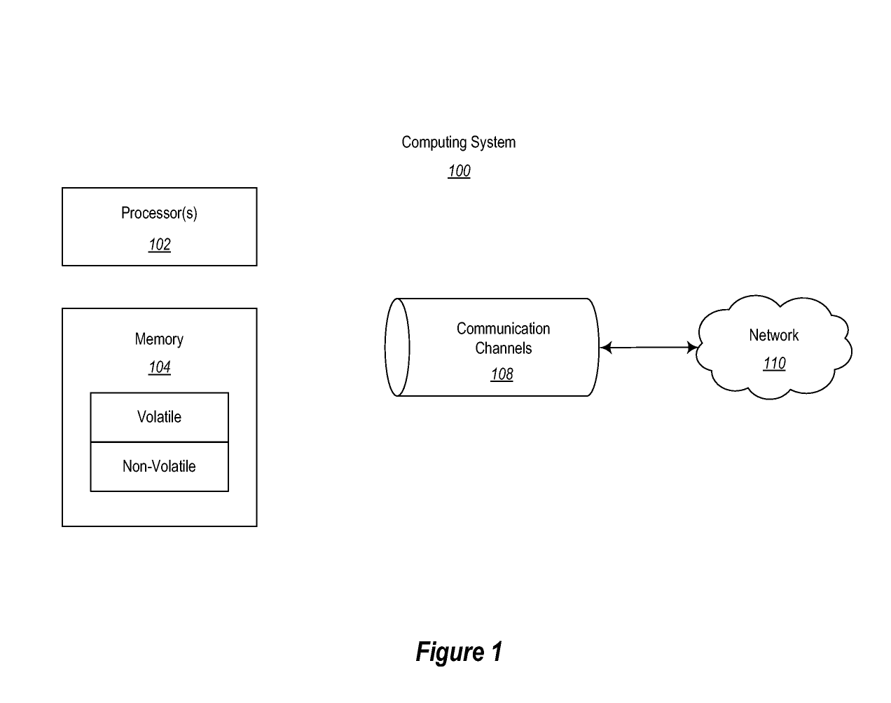

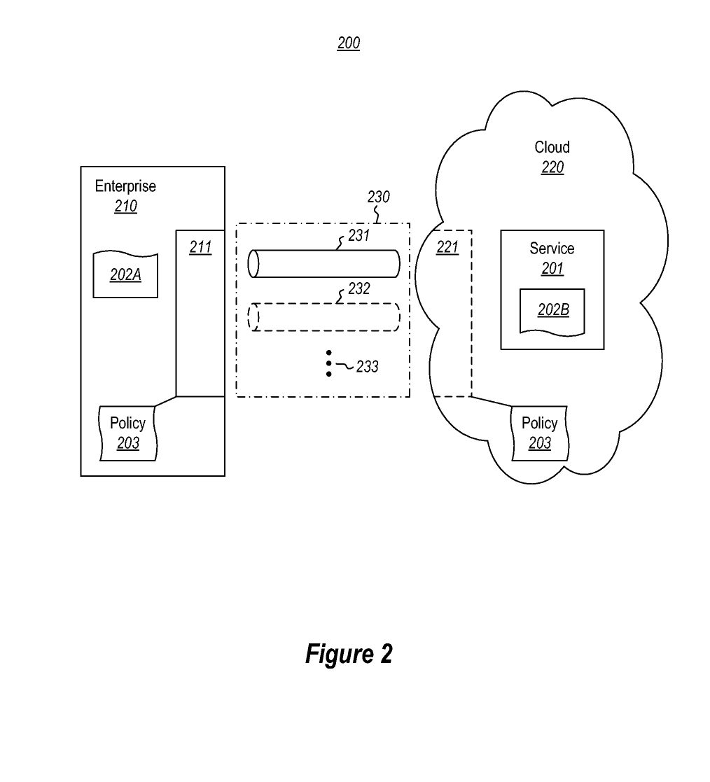

In accordance with at least one embodiment described herein, the cloud service data may be exchanged over any one of a number of different types of communication channels. The enterprise environment includes a delivery controller that is configured to select which communication channel to use to transfer specific data, depending on enterprise policy. Such policy might consider any business goals of the enterprise, and may be applied at the application level. Thus, even cloud service data having to do with the same cloud service might be transferred over different channels to advance the business goals of the enterprise. First, some introductory discussion regarding computing systems will be described with respect to FIG. 1. Then, embodiments of the system and the delivery controller will be described with respect to FIGS. 2 through 8.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2 illustrates a distributed system 200 that includes an enterprise environment 210 and a cloud computing environment 220 in which a cloud service 201 is performed on behalf of the enterprise environment 210. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

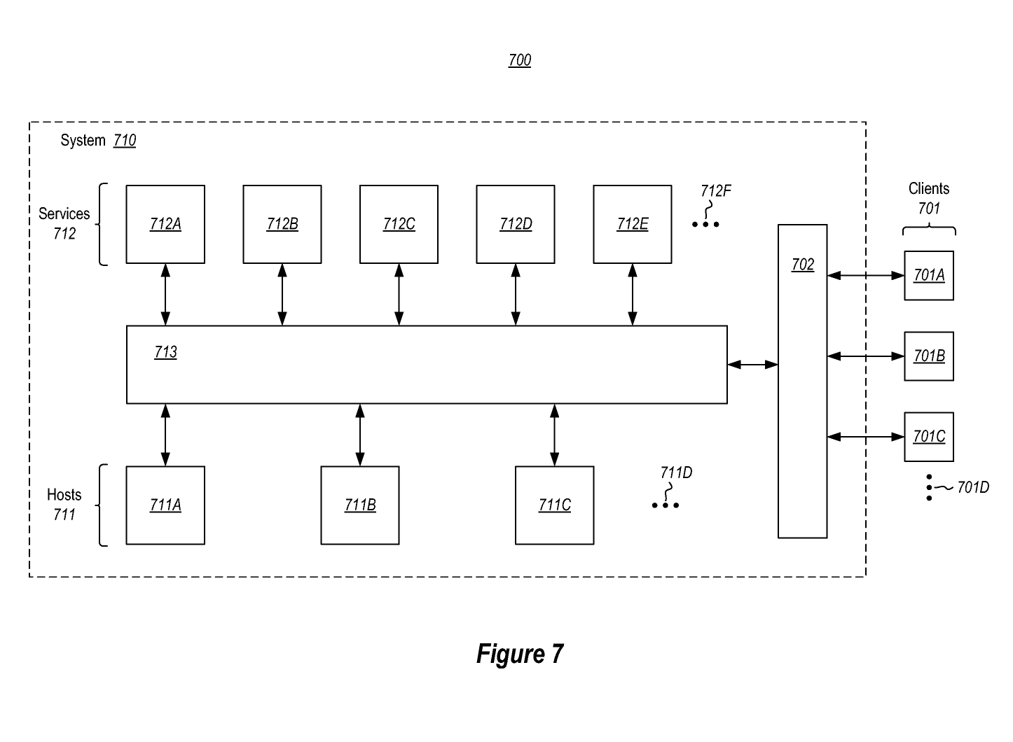

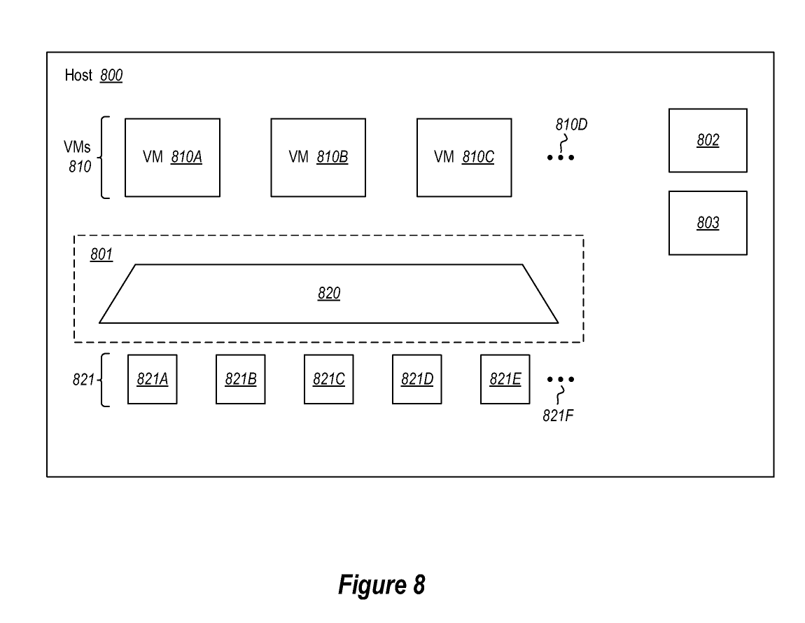

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed. One example of a cloud computing environment will be described with respect to FIGS. 7 and 8, which will be described in further detail below.

Returning to FIG. 2, the enterprise environment 210 may any environment in the control of an enterprise. In this description and in the claims, an “enterprise” is any legal entity in which multiple people collaborate for a common purpose. Examples of an enterprise include a business entity (such as a corporation, company, partnership, firm, division, or the like), a government entity (such as a local, state, federal agency, or international bodies), an ecclesiastical entity (such as a church, diocese, synagogue, mosque, or the like), educational entities (such as universities, schools), medical entities (such as a hospital, or doctor office) standards bodies, of any other entity in which multiple individuals collaborate.

Some of the data (i.e., cloud service data 202B) associated with the cloud service 201 is maintained within the cloud computing environment 220 perhaps by the cloud service 201 itself. Other cloud service data 202A is maintained within the enterprise environment 210. As the cloud service 201 progresses, cloud service data 202 is exchanged between the enterprise environment 210 and the cloud computing environment 220. When exchanging cloud service data, the enterprise environment 210 and the cloud computing environment 220 may use any one of a number of communication channels 230.

For instance, the communication channels 230 are illustrated as including channels 231 and 232, although the ellipses 233 represents that there may be more than two available channels for communication between the enterprise environment 210 and the cloud computing environment 220. As an example, the communication channel 231 might be a dedicated channel for use between the enterprise environment 210 and the cloud computing environment 220. The dedicated channel 231 may be for exclusive use for communication between these two nodes. Perhaps the dedicated channel 231 may have a guaranteed minimum bandwidth. Furthering the example, the communication channel 232 might be a non-dedicated channel (such as the Internet) that is not for exclusive use between the enterprise environment 210 and the cloud computing environment. However, the principles described herein are not limited to these example communication channel types.

The enterprise environment 210 includes an enterprise-side delivery controller 211 that is configured to select which of the communication channels 230 to transfer cloud service data over depending on enterprise policy 203. For instance, the enterprise-side delivery controller 211 may decide which channel to use when transferring cloud service data from the enterprise environment 210 to the cloud computing environment 220. The cloud computing environment 220 also may include a cloud-side delivery controller 221 that is configured to select which of the communication channels 230 to transfer cloud service data over also depending on the enterprise policy 203. For instance, the cloud-side delivery controller 221 may decide which channel to use when transferring cloud service data from the cloud computing environment 210 to the enterprise environment 220.

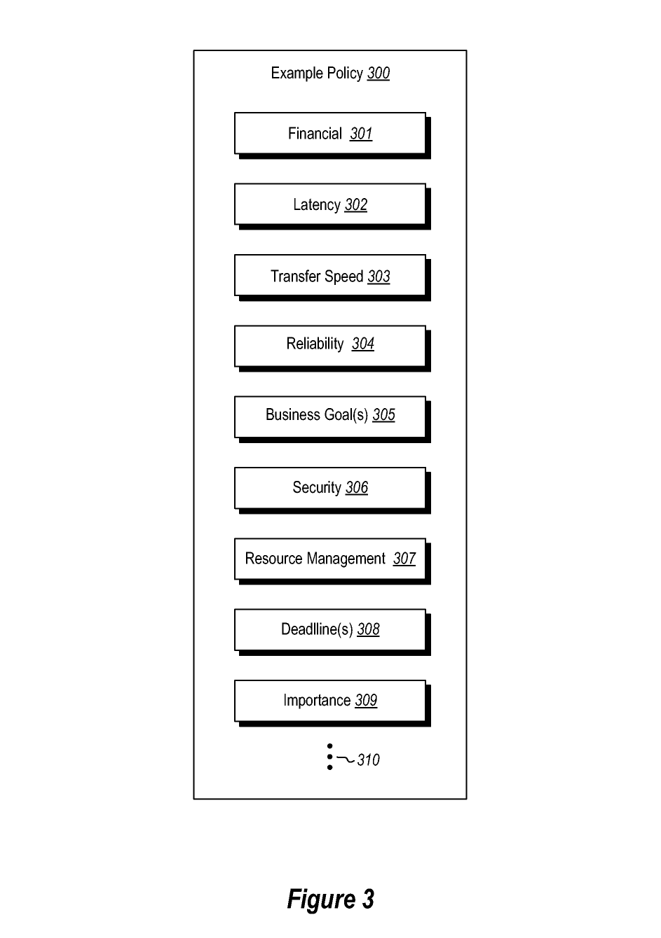

In some embodiments, the enterprise policy 203 may be application-level policy. FIG. 3 illustrates conceptual examples application-level policy 300. For instance, the decision may be based on one or more, or all, of the following considerations: financial considerations 301, latency considerations 302, transfer speed considerations 303, reliability considerations 304, business goal considerations 305, security considerations 306, resource management considerations 307, deadlines 308 associated with the service, and importance 309 of the data or service. However, the ellipses 310 represents that other considerations may be evaluated when determining which channel 230 to use when transferring the cloud service data.

For instance, financial considerations 301 might include a cost of transmitting data of each of the channels 230. A higher cost for transmission might tend more towards more judicious use of that channel, whereas a lower cost for transmission might tend more towards more liberal use of that channel.

Latency considerations 302 involve the latency associated with each channel. If data or circumstances are less sensitive to latency, this would weigh less against the use of higher latency channels that this would if the data and circumstances were more sensitive to latency.

Transfer speed considerations 303 involve the transfer speed desired for the data. If data or circumstances make higher speed transfer more desirable, this might tend the decision towards the use of higher speed channels as compared to if the data and circumstances did not warrant such high transfer speeds.

Reliability considerations 304 involve the reliability of the communication channels. For instance, if the data requires guaranteed delivery, then more reliable communication channels might be used. If the data is sensitive to bit error rate, then the more reliable communication channels might be used. If the communication channel has a guaranteed minimum level of reliability which satisfies the need, then that would suggest use of the more reliable communication channel.

Business goal considerations 305 may also be considered. For instance, perhaps a business goal is to keep the data as secure as possible. In that case, security considerations 306 would warrant a more secure channel (e.g., such as a dedicated channel). The security consideration 306 might also consider whether the data is transmitted in encrypted form or not. If not, and the data is sensitive, this would suggest the use of a secure communication channel.

Resource management considerations 307 might involve levels of current usage of the channel. For instance, if a channel has most of its bandwidth used, and another channel has lower bandwidth utilization, this might lean the decision towards the use of the communication channel that has lower bandwidth utilization.

If there is a deadline 308 associated with the data or the service, the faster communication channel might be used. If the data or service has a high importance 309, then it might be worth it to use the more expensive channel if the communication is faster and/or more secure.

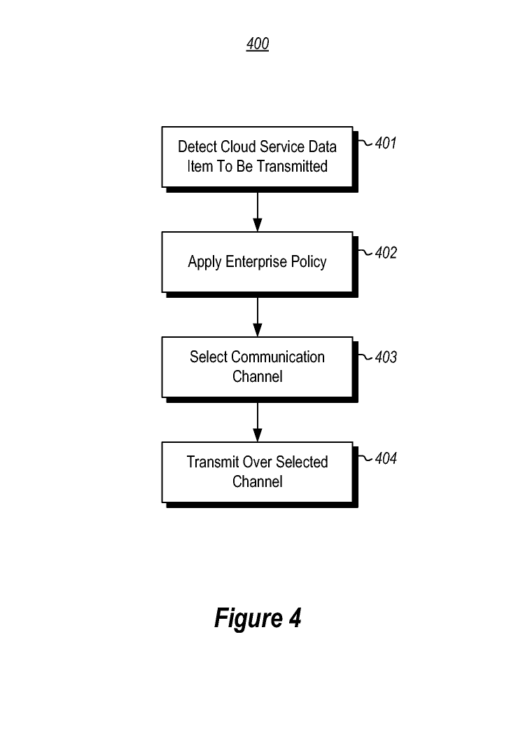

FIG. 4 illustrates a flowchart of a method 400 for communicating cloud service data from an enterprise environment to a cloud service in a cloud computing environment. For instance, the method 400 may be performed in the system 200 of FIG. 2, and thus will now be described with frequent reference to system 200 of FIG. 2. The method 400 may be performed by the enterprise-side delivery controller 211 each time an item of cloud service data is to be transmitted from the enterprise environment 210 to the cloud computing environment 220. The method 400 may likewise be performed by the cloud-side delivery controller 221 each time an item of cloud service data is to be transmitted from the cloud computing environment 220 to the enterprise environment 210.

The method 400 is initiated upon detecting that cloud service data is to be transmitted (act 401). In the case of the enterprise-side delivery controller 211, the cloud service data is to be transmitted from the enterprise environment 210 to the cloud computing environment 220. In the case of the cloud-side delivery controller 221, the cloud service data is to be transmitted from the cloud computing environment 220 to the enterprise environment 210. The appropriate delivery controller 211 or 221 then enumerates the potential communication channels 230 to determine which are available and healthy. The appropriate controller then applies enterprise policy to the item of cloud service data (act 402) to select one of the communication channels 230 over which to communicate the cloud service data (act 403). The appropriate delivery controller 211 or 221 then transmits the cloud service data item over the selected communication channel 230 (act 404).

Thus, depending on the business goals of the enterprise, the delivery controller 211 or 221 may transmit cloud service data associated with a single cloud service over different communication channels to advance the goals of the enterprise. The delivery controller 211 or 221 may perform other functions other than selecting communication channels based on policy. For instance, the delivery controller 211 or 221 may also perform caching of cloud service data associated with the cloud service. This is advantageous in cases in which the delivery controller 211 or 221 might likely need to transmit such data to the other party in the enterprise/cloud pair.

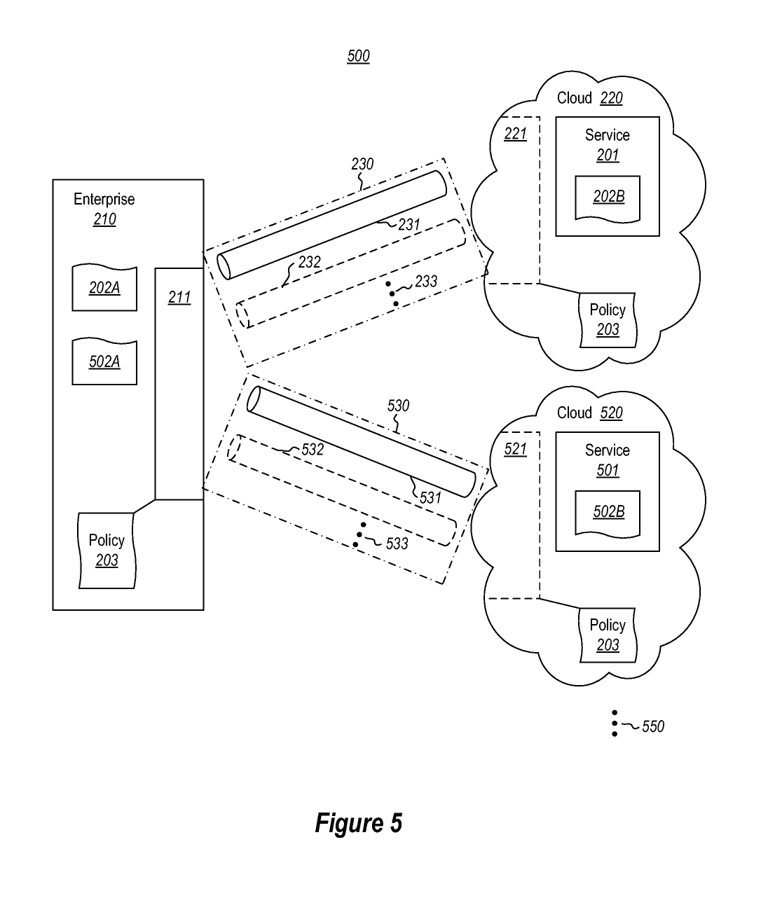

FIG. 2 illustrates a system 200 in which a single enterprise environment 210 communicates with a single cloud computing environment 220. FIG. 5 illustrates a system 500 that is like system 200 except that there are multiple cloud computing environments. Specifically, there is illustrated a second cloud computing environment 520 in which a second cloud service 501 is performed on behalf of the enterprise environment 210. The enterprise environment 210 may communicate with the cloud computing environment 520 in the same manner as described for the cloud computing environment 220 with reference to FIGS. 2 through 4.

For instance, the enterprise environment 210 may also contain a portion of cloud service data 502A associated with the cloud service 501, whereas the cloud computing environment 520 (and perhaps the cloud service 501) has possession of another portion of the cloud service data 502B. The available communication channels 530 between the enterprise environment 210 and the second cloud computing environment 520 includes communication channel 531 (e.g., a dedicated channel), and communication channel 532 (e.g., a non-dedicated channel such as the Internet), and perhaps other communication channels as represented by the ellipses 533.

As a cloud service data item is detected to be delivered to the cloud computing environment 520, the enterprise-side delivery controller 211 decides (based on enterprise policy 203) which of the communication channels 530 to use in order to transmit the cloud service data item, and so transmits the cloud service data item to the cloud computing environment 520 in accordance with the method 400 of FIG. 4. Likewise, as a cloud service data item is detected to be delivered to the enterprise environment 210, the cloud-side delivery controller 521 decides (based on enterprise policy 203) which of the communication channels 530 to use in order to transmit the cloud service data item, and so transmits the cloud service data item to the enterprise environment 210 in accordance with the method 400 of FIG. 4. The ellipses 550 symbolically represent that the enterprise environment 210 may communicate with other cloud computing environments as well using the principles described with reference to FIGS. 2 through 4.

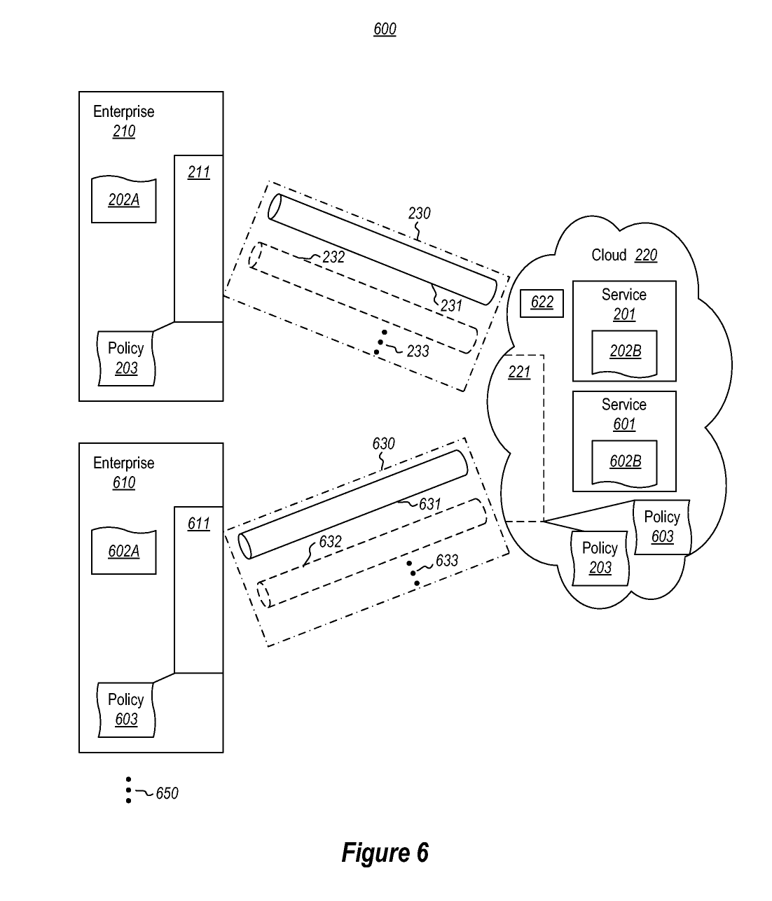

FIG. 5 illustrates a system 500 in which a single enterprise environment 210 communicates with multiple cloud computing environments in accordance with the principles described herein. In contrast, FIG. 6 illustrates a system 600 that is similar to system 200 except that a single cloud computing environment services multiple enterprise environments. Specifically, there is illustrated a second enterprise environment 610 on behalf of which the cloud computing environment 210 is performing a second cloud service 601. The second enterprise environment 610 may communicate with the cloud computing environment 220 in the same manner as described for the first enterprise environment 210 with reference to FIGS. 2 through 4.

For instance, the second enterprise environment 610 may also contain a portion of cloud service data 602A associated with the cloud service 601, whereas the cloud computing environment 220 (and perhaps the cloud service 601) has possession of another portion of the cloud service data 602B. The available communication channels 630 between the second enterprise environment 610 and the cloud computing environment 220 includes communication channel 631 (e.g., a dedicated channel), and communication channel 632 (e.g., a non-dedicated channel such as the Internet), and perhaps other communication channels as represented by the ellipses 633.

As a cloud service data item is detected to be delivered from the second enterprise environment 610 to the cloud computing environment 220, the enterprise-side delivery controller 611 decides (based on enterprise policy 603) which of the communication channels 630 to use in order to transmit the cloud service data item, and so transmits the cloud service data item to the cloud computing environment 220 in accordance with the method 400 of FIG. 4. Likewise, as a cloud service data item is detected to be delivered to the second enterprise environment 610, the cloud-side delivery controller 221 decides (based on enterprise policy 603) which of the communication channels 630 to use in order to transmit the cloud service data item, and so transmits the cloud service data item to the second enterprise environment 610 in accordance with the method 400 of FIG. 4. The ellipses 650 symbolically represent that the cloud computing environment 220 may communicate with other enterprise environments as well using the principles described with reference to FIGS. 2 through 4.

In accordance with some embodiments described herein, the cloud computing environment further includes a policy push controller 622 configured to push policy to the first enterprise-side delivery controller 211 and the second enterprise-side delivery controller 611. For instance, suppose that enterprise environments 210 and 610 are two divisions of a corporation, and that some aspects of policy 203 and 603 are to be the same. The corporation may indicate this to the push controller 622, thereby causing the policy to be incorporated into the enterprise policy 203 and 603 on both the cloud computing environment 220 and each of the enterprise environments 210 and 610.

FIGS. 7 and 8 illustrate an embodiment of a cloud computing environment that may represent the cloud computing environment 220 of FIG. 2, 5 or 6. FIG. 7 abstractly illustrates a cloud computing environment in which the principles described herein may be employed. The environment 700 includes multiple clients 701 interacting with a system 710 using an interface 702. The environment 700 is illustrated as having three clients 701A, 701B and 701C, although the ellipses 701D represent that the principles described herein are not limited to the number of clients interfacing with the system 710 through the interface 702. The system 710 may provide services to the clients 701 on-demand and thus the number of clients 701 receiving services from the system 710 may vary over time. The clients 701 may be part of the enterprise environment (e.g., the enterprise environment 210 of FIGS. 2, 5 and 6; enterprise environment 510 of FIG. 5; or enterprise environment 610 of FIG. 6). Alternatively or in addition, the clients 701 may represent customers of the enterprises represented by the enterprise environment 210, 510 or 610. For instance, if the enterprises provide a web service, the clients 701 may represent individuals navigating to the web site.

Each client 701 may, for example, be structured as described above for the computing system 100 of FIG. 1. Alternatively or in addition, the client may be an application or other software module that interfaces with the system 710 through the interface 702. The interface 702 may be an application program interface that is defined in such a way that any computing system or software entity that is capable of using the application program interface may communicate with the system 710.

The system 710 may be a distributed system, although not required. In one embodiment, the system 710 is a cloud computing environment. Cloud computing environments may be distributed, although not required, and may even be distributed internationally and/or have components possessed across multiple organizations.

The system 710 includes multiple hosts 711, that are each capable of running virtual machines. Although the system 700 might include any number of hosts 711, there are three hosts 711A, 711B and 711C illustrated in FIG. 7, with the ellipses 711D representing that the principles described herein are not limited to the exact number of hosts that are within the system 710. There may be as few as one, with no upper limit. Furthermore, the number of hosts may be static, or might dynamically change over time as new hosts are added to the system 710, or as hosts are dropped from the system 710. Each of the hosts 711 may be structured as described above for the computing system 100 of FIG. 1.

Each host is capable of running one or more, and potentially many, virtual machines. For instance, FIG. 8 abstractly illustrates a host 800 in further detail. As an example, the host 800 might represent any of the hosts 711 of FIG. 7. In the case of FIG. 8, the host 800 is illustrated as operating three virtual machines 810 including virtual machines 810A, 810B and 810C. However, the ellipses 810D once again represents that the principles described herein are not limited to the number of virtual machines running on the host 800. There may be as few as zero virtual machines running on the host with the only upper limit being defined by the physical capabilities of the host 800.

During operation, the virtual machines emulates a fully operational computing system including an at least an operating system, and perhaps one or more other applications as well. Each virtual machine is assigned to a particular client, and is responsible to support the desktop environment for that client.

The virtual machine generates a desktop image or other rendering instructions that represent a current state of the desktop, and then transmits the image or instructions to the client for rendering of the desktop. For instance, referring to FIGS. 7 and 8, suppose that the host 800 of FIG. 8 represents the host 711A of FIG. 7, and that the virtual machine 810A is assigned to client 701A (referred to herein as “the primary example”), the virtual machine 810A might generate the desktop image or instructions and dispatch such instructions to the corresponding client 701A from the host 711A via a service coordination system 713 and via the system interface 702.

As the user interacts with the desktop at the client, the user inputs are transmitted from the client to the virtual machine. For instance, in the primary example and referring to FIGS. 7 and 8, the user of the client 701A interacts with the desktop, and the user inputs are transmitted from the client 701 to the virtual machine 810A via the interface 701, via the service coordination system 713 and via the host 711A.

The virtual machine processes the user inputs and, if appropriate, changes the desktop state. If such change in desktop state is to cause a change in the rendered desktop, then the virtual machine alters the image or rendering instructions, if appropriate, and transmits the altered image or rendered instructions to the client computing system for appropriate rendering. From the prospective of the user, it is as though the client computing system is itself performing the desktop processing.

The host 800 includes a hypervisor 820 that emulates virtual resources for the virtual machines 810 using physical resources 821 that are abstracted from view of the virtual machines 810. The hypervisor 821 also provides proper isolation between the virtual machines 810. Thus, from the perspective of any given virtual machine, the hypervisor 820 provides the illusion that the virtual machine is interfacing with a physical resource, even though the virtual machine only interfaces with the appearance (e.g., a virtual resource) of a physical resource, and not with a physical resource directly. In FIG. 8, the physical resources 821 are abstractly represented as including resources 821A through 821F. Examples of physical resources 821 including processing capacity, memory, disk space, network bandwidth, media drives, and so forth.

The host 800 may operate a host agent 802 that monitors the performance of the host, and performs other operations that manage the host. Furthermore, the host 800 may include other components 803.

Referring back to FIG. 7, the system 700 also includes services 712. In the illustrated example, the services 700 include five distinct services 712A, 712B, 712C, 712D and 712E, although the ellipses 712F represent that the principles described herein are not limited to the number of service in the system 710. A service coordination system 713 communicates with the hosts 711 and with the services 712 to thereby provide services requested by the clients 701, and other services (such as authentication, billing, and so forth) that may be prerequisites for the requested service.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
an enterprise environment;
a cloud computing environment in which a cloud service is performed on behalf of the enterprise environment; and
a plurality of different communication channels between the enterprise environment and the cloud computing environment,
wherein the enterprise environment includes an enterprise-side delivery controller that is configured to select which of the plurality of communication channels to transfer cloud service data over depending on enterprise policy.

2. The system of claim 1, wherein one of the plurality of communication channels is the Internet.

3. The system of claim 2, wherein another of the plurality of communication is a dedicated channel between the enterprise environment and the cloud computing environment.

4. The system of claim 1, wherein the cloud computing environment includes a cloud-side delivery controller that is configured to select which of the plurality of communication channels to transfer cloud service data depending on the enterprise policy.

5. The system in accordance with claim 1, wherein the enterprise policy as application-level policy.

6. The system in accordance with claim 5, wherein the enterprise policy includes financial considerations of communicating over the various plurality of communication channels.

7. The system in accordance with claim 5, wherein the enterprise policy includes latency considerations of communicating over the various plurality of communication channels.

8. The system in accordance with claim 5, wherein the enterprise policy includes transfer speed considerations of communicating over the various plurality of communication channels.

9. The system in accordance with claim 5, wherein the enterprise policy includes reliability considerations of communicating over the various plurality of communication channels.

10. The system in accordance with claim 5, wherein the enterprise policy includes business goal considerations of communicating over the various plurality of communication channels.

11. The system in accordance with claim 5, wherein the enterprise policy includes security considerations of communicating over the various plurality of communication channels.

12. The system in accordance with claim 5, wherein the enterprise policy includes resource management considerations of communicating over the various plurality of communication channels.

13. The system in accordance with claim 5, wherein the enterprise policy includes a deadline associated with service completion of the cloud service.

14. The system in accordance with claim 5, wherein the enterprise policy includes an importance associated with the service completion.

15. The system in accordance with claim 1, wherein the enterprise-side delivery controller also performs caching of cloud service data associated with the cloud service.

16. The system in accordance with claim 1, wherein the cloud computing environment is a first cloud computing environment, the plurality of communication channels is a first plurality of communication channels, and the cloud service is a first cloud service, the system further comprising:
a second cloud computing environment in which a second cloud service is performed on behalf of the enterprise environment; and
a second plurality of different communication channels between the enterprise environment and the second cloud computing environment,
wherein the enterprise-side delivery controller that is also configured to select which of the second plurality of communication channels to transfer cloud service data between the enterprise environment and the second cloud computing environment depending on the enterprise policy.

17. The system in accordance with claim 1, wherein the cloud service is a first cloud service, the enterprise environment is a first enterprise environment, the enterprise-side delivery controller is a first enterprise-side delivery controller, the plurality of communication channels is a first plurality of communication channels, and the enterprise policy is first enterprise policy, the system further comprising:
a second enterprise environment, wherein the cloud computing environment performs a second cloud service on behalf of the second enterprise environment; and
a second plurality of different communication channels between the second enterprise environment and the cloud computing environment,
wherein the second enterprise environment includes a second enterprise-side delivery controller that is configured to select which of the second plurality of communication channels to transfer cloud service data over depending on second enterprise policy.

18. The system in accordance with claim 17, wherein the cloud computing environment further includes a policy push controller configured to push policy to the first enterprise-side delivery controller and the second enterprise-side delivery controller.

19. A method for communicating cloud service data from an enterprise environment to a cloud service in a cloud computing environment the method comprising:
detecting that first cloud service data is to be transmitted from the enterprise environment to the cloud service;
applying enterprise policy to the first cloud service data to select a first of a plurality of different communication channels to communicate the first cloud service data over;
transmitting the first cloud service data of over the first selected communication channel to the cloud service;
detecting that second cloud service data is to be transmitted from the enterprise environment to the cloud service;
applying the enterprise policy to the second cloud service data to select a second of a plurality of different communication channels to communicate the first cloud service data over; and
transmitting the second cloud service data of over the second selected communication channel to the cloud service.

20. A system comprising:
an enterprise environment;
a cloud computing environment in which a cloud service is performed on behalf of the enterprise environment;
a dedicated communication channels between the enterprise environment and the cloud computing environment, and
a non-dedicated communication channel between the enterprise environment and the cloud computing environment,
wherein the enterprise environment includes an enterprise-side delivery controller that is configured to select whether to communicate cloud service data over the dedicated communication channel or the non-dedicated communication channel depending on enterprise policy.
